(19) United States
(12) Patent Application Publication
(10) Pub. No.: US 2002/0044058 A1
(43) Pub. Date: Apr. 18, 2002

(54) Wrist mounted RFID reader and/or antenna

(76) Inventors: Harley Kent Heinrich, Brewster, NY (US); Winston V. Guillory JR., Dallas, TX (US)

Correspondence Address: O'MELVENY & MYERS LLP, 400 So. Hope Street, Los Angeles, CA, 90071-2899, US

(21) Appl. No.: 09/929,461

(22) Filed: Aug. 14, 2001

Related U.S. Application Data
(60) Provisional application No. 60/225,890, filed on Aug. 17, 2000.

(51) Int. Cl. G08B 13/14

(52) U.S. Cl. 340/572.1; 340/573.1

(57) ABSTRACT

An apparatus for scanning radio frequency identification (RFID) data from at least one RFID tag comprises a hands-free RFID reader that enables an operator to read or identify items having RFID tags without using the hands. The apparatus comprises a housing containing at least a portion of an RFID scanner. The housing can be affixed to a portion of an operator's body, such as a hand or wrist, using a strap or other like attachment. The RFID scanner further comprises an antenna, a radio transmitter/receiver coupled to the antenna, and a processor adapted to control operation of the radio transmitter/receiver. In an embodiment of the invention, the housing contains the antenna, and the radio transmitter/receiver and processor are disposed externally of the housing. In another embodiment of the invention, the housing contains the antenna, the radio transmitter/receiver, and the processor. The housing may further contain a power source adapted to provide power for the RFID scanner. The RFID scanner may also be adapted to communicate the RFID data to an external system, such as via a wireless or infrared connection.

### RELATED APPLICATION DATA

This application claims priority pursuant to 35 U.S.C. §119(e) to provisional patent application Ser. No. 60/225,890, filed Aug. 17, 2000, which application is specifically incorporated herein, in its entirety, by reference.

### BACKGROUND OF THE INVENTION

1. Field of the Invention

The present invention relates to automated data collection systems that collect information from radio frequency identification (RFID) transponders, and more particularly, to a wrist or hand-mounted RFID antenna or combined reader and antenna that allows an operator to read or identify RFID tagged items without using the hands.

2. Description of Related Art

In the automatic data identification industry, the use of RFID transponders (also known as RFID tags) has grown in prominence as a way to track data regarding an object to which the RFID transponder is affixed. An RFID transponder generally includes a semiconductor memory in which digital information may be stored, such as an electrically erasable, programmable read-only memory (EEPROM) or similar electronic memory device. An RFID interrogator or reader may recover the digital information stored in the RFID transponder using modulated radio frequency (RF) signals. One such communication technique is referred to as “backscatter modulation,” by which an RFID transponder transmits stored data by reflecting varying amounts of an electromagnetic field provided by the RFID interrogator by modulating the antenna matching impedance of the transponder. The RFID transponder can therefore operate independently of the frequency of the energizing field, and as a result, the interrogator may operate at multiple frequencies so as to avoid RF interference, such as utilizing frequency hopping spread spectrum modulation techniques. The RFID transponders may either extract power from the electromagnetic field provided by the interrogator, or include an internal power source (e.g., battery).

Since RFID transponders using backscatter modulation do not include a radio transceiver, they can be manufactured in very small, lightweight and hence inexpensive units. RFID transponders that extract power from the interrogating field are particularly cost effective since they lack a power source. In view of these advantages, RFID transponders can be used in applications in which it is desirable to track information regarding an object, including inventory management, retailing, shipping and distribution, vehicle toll collection, and many others.

In some applications, it is desirable for an operator to be able to manually handle the objects in order to use, pack or move the objects. RFID readers are typically provided in portable devices, such as a hand-held reader or data terminal. While these portable devices are more convenient than fixed position readers or scanners, they nevertheless require the operator to hold the device during a reading operation. After an RFID tag has been scanned, the operator then must put the reader down to free the hand for other manual tasks. This repeated grasping and returning of the RFID reader reduces the productivity of the operator. It is known in the art to provide “hands free” readers for bar code data that are mounted to an operator's finger or wrist, thereby leaving the operator's hands free for other tasks; however, such hands-free systems have not been adapted for reading RFID tags.

Accordingly, it would be desirable to provide a hands-free RFID reader to enable an operator to read or identify items having RFID tags without using the hands.

### SUMMARY OF THE INVENTION

In accordance with the teachings of the present invention, an apparatus for scanning radio frequency identification (RFID) data from at least one RFID tag is provided. The apparatus comprises a hands-free RFID reader that enables an operator to read or identify items having RFID tags without using the hands. Move particularly, the apparatus comprises a housing containing at least a portion of an RFID scanner. The housing can be affixed to a portion of an operator's body, such as a hand or wrist, using a strap or other like attachment. The RFID scanner further comprises an antenna, a radio transmitter/receiver coupled to the antenna, and a processor adapted to control operation of the radio transmitter/receiver. In an embodiment of the invention, the housing contains the antenna, and the radio transmitter/receiver and processor are disposed externally of the housing. In another embodiment of the invention, the housing contains the antenna, the radio transmitter/receiver, and the processor. The housing may further contain a power source adapted to provide power for the RFID scanner. The RFID scanner may also be adapted to communicate the RFID data to an external system, such as via a wireless or infrared connection.

A more complete understanding of a wrist mounted RFID reader and/or antenna will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 is a block diagram of an RFID tag and reader;

FIG. 2 is a perspective view of a first embodiment of the RFID reader; and

FIG. 3 is a perspective view of a second embodiment of the RFID reader.

### DETAILED DESCRIPTION OF THE PREFERRED EMBODIMENT

The present invention satisfies the need for a hands-free RFID reader that enables an operator to read or identify items having RFID tags without using the hands. In the detailed description that follows, like element numerals are used to describe like elements illustrated in one or more of the figures.

Referring first to FIG. 1, an exemplary RFID reader 20 and RFID tag 30 is illustrated. The exemplary RFID reader 20 comprises a processor 24, a memory 26 and a radio module 22. The processor 24 receives and processes data signals recovered from the RFID tag 30 and communicates the collected information with other systems, such as a server computer. The term “processor” as generally used herein refers to any logic processing unit, such as one or more central processing units (CPUs), digital signal processors (DSPs), application specific integrated circuits (ASICs), field programmable gate arrays (FPGAs), and the like. The memory 26 includes a random access memory (RAM) and a read-only memory (ROM) to provide storage for program instructions, parameters and data for the processor 24. More particularly, the memory 26 contains stored instructions that are executed by the processor 24 to cause the processor to receive, write, and/or manipulate data recovered from the RFID tag 30. The memory 26 may further comprise a flash memory or electronically erasable programmable read-only memory (EEPROM). The RFID reader 20 may further include additional peripheral systems, such as a display, keyboard, printer, fixed memory storage device, and the like, that communicate with the processor 24.

The exemplary radio module 22 provides for RF communications to/from the RFID tag 30 under the control of the processor 24. The radio module 22 further comprises a transmitter portion 22a, a receiver portion 22b, and a hybrid 22c. The antenna 28 is coupled to the hybrid 22c. The hybrid 22c may further comprise a circulator, directional coupler, or like component that permits bi-directional communication of signals with sufficient signal isolation. The transmitter portion 22a includes a local oscillator that generates an RF carrier frequency. The transmitter portion 22a sends a transmission signal modulated by the RF carrier frequency to the hybrid 22c, which in turn passes the signal to the antenna 28. The antenna 28 broadcasts the modulated signal and captures signals radiated by the RFID tag 30. The antenna 28 then passes the captured signals back to the hybrid 22c, which forwards the signals to the receiver portion 22b. The receiver portion 22b mixes the captured signals with the RF carrier frequency generated by the local oscillator to directly downconvert the captured signals to a baseband information signal. The baseband information signal may comprises two components in quadrature, referred to as the I (in phase with the transmitted carrier) and the Q (quadrature, 90 degrees out of phase with the carrier) signals. The hybrid 22c connects the transmitter 22a and receiver 22b portions to the antenna 28 while isolating them from each other. In particular, the hybrid 22c allows the antenna 28 to send out a strong signal from the transmitter portion 22a while simultaneously receiving a weak backscattered signal reflected from the RFID tag 30. It should be appreciated that other known embodiments of the RFID reader 20, and particularly the radio module 22, could also be advantageously utilized within the scope of the present invention.

The exemplary RFID tag 30 includes an RF interface 34, control logic 36 and memory 38. The RF interface 34 is coupled to an antenna 32, and may include an RF receiver that recovers analog signals that are transmitted by the RFID reader 20 and an RF transmitter that sends data signals back to the RFID reader. The RF transmitter may further comprise a modulator adapted to backscatter modulate the impedance match with the antenna 32 in order to transmit data signals by reflecting a continuous wave (CW) signal provided by the RFID reader 20. The control logic 36 controls the functions of the RFID tag 30 in response to commands provided by the RFID reader 20 that are embedded in the recovered RF signals. The control logic 36 accesses the memory 38 to read and/or write data therefrom. The control logic 36 also converts analog data signals recovered by the RF interface 34 into digital signals comprising the received commands, and converts digital data retrieved from the memory 38 into analog signals that are backscatter modulated by the RF interface 34. The RFID tag 30 may be adapted to derive electrical power from the interrogating signal provided by the RFID reader 20, or may include an internal power source (e.g., battery) (not shown).

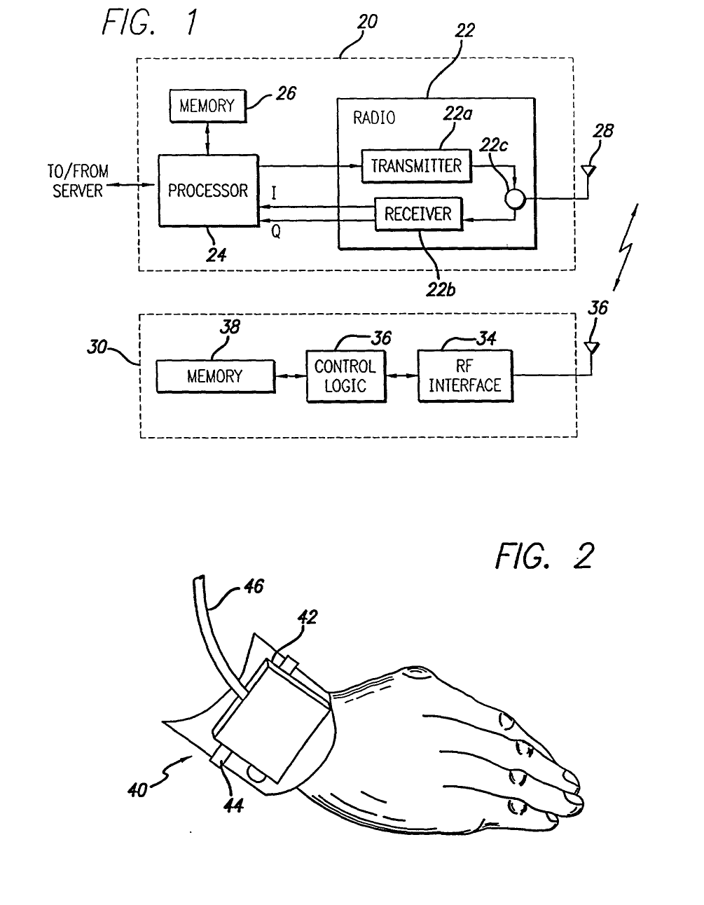

Referring now to FIG. 2, an embodiment of an RFID scanner 40 is illustrated. The RFID scanner 40 comprises a housing 42 that is affixed to an operator's wrist with strap 44 or other like attachment device. The housing 42 may include both the RFID reader and antenna (as described above with respect to Fig.1). An optional cable 46 may be used to couple the RFID reader to an external systems, such as a portable data terminal located elsewhere on the operator or disposed remotely. Alternatively, the housing 42 may include only the antenna, and the cable 46 would extend from the back of the housing to an RFID reader that is separately disposed, such as mounted to another part of the operators body or physically located remotely from the operator. The RFID reader/antenna housing 42 may include an internal power source (e.g., battery) and could communicate externally via any of the well known wireless communication techniques such as wireless local area network (LAN), infrared, personal area networks or wide area networks.

In an embodiment of the invention, the RFID scanner 40 would read RFID tags automatically as they come into proximity with the scanner, without physical intervention by the operator. The RFID scanner 40 may be in a constant ready state in which it is periodically transmitting an interrogating signal to determine if an RFID tag has been brought into proximity. Alternatively, the RFID scanner 40 may have the capability of being selectively enabled or disabled. The disabled state may be selected, for example, to conserve battery power of the RFID scanner 40 during periods of non-use. The operator may be able to selectively enable or disable the RFID scanner 40, such as by activating a switch or button disposed on the housing 42 or disposed in an alternate location (e.g., a foot pedal). In like manner, the operator may also be able to initiate a scanning operation by activating a switch or button. The RFID scanner 40 may also be selectively enabled or disabled under the control of other systems, such as by a network connected to the RFID scanner.

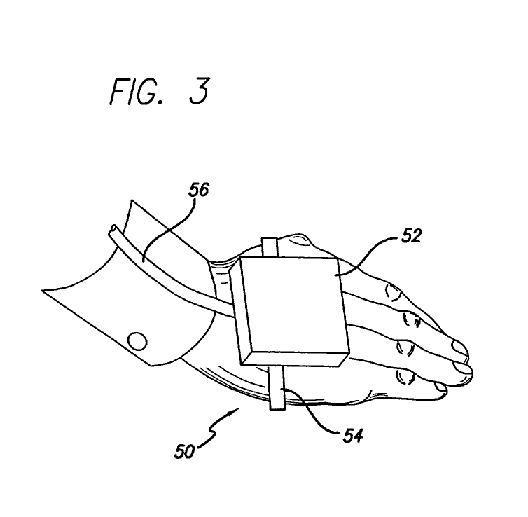

FIG. 3 illustrates another embodiment of an RFID scanner 50. The RFID scanner 50 comprises a housing 52 that is affixed to an operator's hand with strap 54. As with the embodiment of FIG. 2, the housing 52 may include both the RFID reader and antenna. Alternatively, the housing 52 may include only the antenna, and would be coupled to an RFID reader using optional cable 56. It should be appreciated that the RFID scanner could also be mounted to many other locations on the operator's body, such as the finger, belt, back or head. The RFID scanner 50 would otherwise operate in like manner as the RFID scanner 40 described above.

Having thus described a preferred embodiment of a wrist mounted RFID reader and/or antenna, it should be apparent to those skilled in the art that certain advantages of the invention have been achieved. It should also be appreciated that various modifications, adaptations, and alternative embodiments thereof may be made within the scope and spirit of the present invention. The invention is further defined by the following claims.

What is claimed is:

1. An apparatus for scanning radio frequency identification (RFID) data from at least one RFID tag, comprising:
a housing containing at least a portion of an RFID scanner; and
means for affixing the housing to a portion of an operator's body.

2. The apparatus of claim 1, wherein said RFID scanner further comprises an antenna, a radio transmitter/receiver coupled to the antenna, and a processor adapted to control operation of the radio transmitter/receiver.

3. The apparatus of claim 2, wherein said housing contains said antenna, and said radio transmitter/receiver and processor are disposed externally of said housing.

4. The apparatus of claim 2, wherein said housing contains said antenna, said radio transmitter/receiver, and said processor.

5. The apparatus of claim 4, wherein said housing further contains a power source adapted to provide power for said RFID scanner.

6. The apparatus of claim 1, wherein said affixing means further comprises a strap adapted to affix the housing to a wrist or hand of the operator.

7. The apparatus of claim 1, further comprising means for communicating said RFID data to an external system.

8. The apparatus of claim 7, wherein said communicating means further comprises a wireless local area network.

9. The apparatus of claim 7, wherein said communicating means further comprises an infrared link.

10. A system for collecting radio frequency identification (RFID) data, comprising:
a housing containing at least a portion of an RFID scanner;
means for affixing the housing to a portion of an operator's body; and
at least one RFID tag;
wherein, the RFID scanner is adapted to scan said at least one RFID tag when disposed in proximity to said housing.

11. The system of claim 10, wherein said RFID scanner further comprises an antenna, a radio transmitter/receiver coupled to the antenna, and a processor adapted to control operation of the radio transmitter/receiver.

12. The system of claim 11, wherein said housing contains said antenna, and said radio transmitter/receiver and processor are disposed externally of said housing.

13. The system of claim 11, wherein said housing contains said antenna, said radio transmitter/receiver, and said processor.

14. The system of claim 13, wherein said housing further contains a power source adapted to provide power for said RFID scanner.

15. The system of claim 10, wherein said affixing means further comprises a strap adapted to affix the housing to a wrist or hand of the operator.

16. The system of claim 10, further comprising means for communicating said RFID data to an external system.

17. The system of claim 16, wherein said communicating means further comprises a wireless local area network.

18. The system of claim 16, wherein said communicating means further comprises an infrared link.

19. The system of claim 16, wherein said RFID scanner automatically scans said at least one RFID tag without manual intervention by the operator.

20. The system of claim 16, wherein said RFID scanner scans said at least one RFID tag under command by the operator.
